(19) United States
(12) Patent Application Publication
(10) Pub. No.: US 2011/0287475 A1
(43) Pub. Date: Nov. 24, 2011

(54) Tissue Fixative Having Increased Viscosity

(75) Inventors: Reza A. Ardekani, Chester Springs, PA (US); Phillip R. Britton, Chester Springs, PA (US); Laurie S. Claxton, Chester Springs, PA (US)

(73) Assignee: AZER SCIENTIFIC, INC., Morgantown, PA (US)

(21) Appl. No.: 13/112,732

(22) Filed: May 20, 2011

Related U.S. Application Data
(60) Provisional application No. 61/346,535, filed on May 20, 2010.

(51) Int. Cl. G01N 1/28

(52) U.S. Cl. 435/40.5

(57) ABSTRACT

A gel fixative composition having increased, viscosity which fixes tissues as well as or better than standard liquid fixative solutions. The gel fixative compositions are less prone to leakage and are less likely to splash or spill from containers when they are mishandled. Because of their viscosity, they are less likely to penetrate surfaces and are more easily cleaned up if spilled. A method of making mixing biological fixative by mixing a solution of a biological fixative with a with a high-shear mixer at about 400 to 600 rpm; dispersing uniformly over time about 0.2 to about 2.0 weight percent of thickener while mixing for 2 to 10 minutes; increasing the mixing speed to about 1000 to 1500 rpm; and then, mixing for about 90 to 120 minutes so that a gel fixative composition is formed having a viscosity between about 1,000 cp and 200,000 cp.

### CROSS REFERENCE TO RELATED APPLICATIONS

This non-provisional application claims benefit under 35 U.S.C, §119(e) from U.S. Provisional Patent Application 61/346,535 filed May 20, 2010. The entire disclosure of the aforementioned application is incorporated herein by reference.

### TECHNICAL FIELD

This invention pertains to tissue fixative compositions with increased viscosity, which property provides more favorable transport and spill-preventive properties.

### BACKGROUND OF THE INVENTION

A tissue fixative is a product that preserves cells in their natural state for further examination. Generally, tissue fixatives are available as liquid formulations. A common application is to have the fixative formulation presented in “pre-filled” containers. Containers, in a variety of sizes, typically but not necessarily made from plastic, are shipped from the manufacturer to the laboratory, or other medical facility where tissue is excised and the tissue is then placed into the “pre-filled” containers and put in direct contact with the fixative for fixation and for transport to other facilities. These “pre-filled” containers are shipped routinely by parcel post carriers to the point of use and again shipped to a lab for analysis and histological diagnosis. The containers can be easily damaged in transit or the lids can become loose due to thermal cycling and rough handling. A single fixative spill can be costly both in dollars and in environmental impact as HAZMAT procedures are often used to clean a spill. In addition, the loss of a patient specimen can be traumatic for the patient and extremely costly.

A common fixative is 10% neutral buffered formalin. 10% neutral buffered formalin is a 1:10 dilution of 100% formalin in water, i.e. 1 part saturated formaldehyde in water diluted with 9 parts plain water. Since 100% formalin contains 40% formaldehyde, a 1:10 dilution, would contain 4% formaldehyde. Many other fixatives are also packaged in prefilled containers. A partial listing of fixatives that are used in a similar fashion to 10% neutral buffered formalin includes 10% neutral phosphate buffered formalin, 10% neutral phosphate unbuffered formalin, neutral buffered formalin, buffered zinc formalin, formalin substitute, formaldehyde solution (37% by weight), alcohol formalin (containing alcohol, barium chloride, formalin), Millonig's modified phosphate buffer formalin concentrate, 10% Millonig's modified phosphate Buffer Formalin concentrate, Bouin's Solution, zinc formalin, acetic zinc formalin. Michel's Transport Medium, glutaradehyde 3%. B-5 fixative mercuric free. Each of the above formulations is a liquid formulation. These fixatives are available in a variety of configurations including pre-filled individual specimen containers and bulk.

### SUMMARY OF THE INVENTION

The present invention comprises a gel fixative composition having increased viscosity that achieves one or more of the following functions: (1) fixes tissues as well or better than the currently used liquid formulations: (2) remains optically clear for visual inspection; (3) leaves little or no artifact of any of the added ingredients on the fixed tissue; (4) does not interfere with any of the tests that fixed tissues currently undergo; (5) is less susceptible to leakage during transport; (6) is less likely to splash or spill as a result of mishandling containers in use; and (7) will naturally remain more contained and be less likely to penetrate packaging or contaminate the immediate environment in the event of a leak or spill.

The gel fixative compositions have the advantage of being more easily contained if they are spilled or transported. Because of their viscosity, they are less likely to be splashed from a sample testing device, if spilled, the viscous gel fixative compositions are less likely to penetrate or spread on a surface than liquid, fixative solutions.

In one embodiment of the invention, the gel fixative composition comprises a biological fixative solution and about 0.2 to 2.0 weight percent of a thickener, It is preferred that the gel fixative composition comprises 0.5 to 1.5 weight percent of the thickener. It is most preferred that the gel fixative composition comprises 0.9 to 1.1 weight percent of the thickener.

The biological, fixative may be a formaldehyde-containing fixative. It is preferred that the formaldehyde-containing fixative be either 10% neutral phosphate buffered formalin, 10% neutral phosphate unbuffered formalin, neutral buffered formalin, neutral buffered (pH 7.0) formalin containers, Carson Millonig (pH 7.4) formalin containers, buffered zinc formalin, formaldehyde solution (37% by weight), alcohol formalin, Millonig's modified phosphate buffer formalin concentrate, 10% Millonig's modified phosphate buffer formalin concentrate, zinc formalin, acetic zinc formalin, Michel's Transport Medium, Hartmann's fixative, Hollandes Fixative, Bouin's fixative, or Karnovsky's fixative. A most preferred embodiment of the invention is a solution of 10% formalin or 10% neutral buffered formalin.

The thickener is selected from the group of polysaccharides, polyacrylates, synthetic silicates, clays, or gums. In a preferred embodiment, the thickener is a gum and most preferably a xanthan gum. Representative polysaccharide thickeners are alginates or cellulose derivatives. Preferred cellulose derivatives include hydroxypropylcellulose, hydroxyethylcellulose, and hydroxyethyl ethylcellulose.

The present invention also comprises a method for preparing a gel fixative composition, wherein a thickener is added to a liquid fixative solution to produce a gel with fixing properties that are as good as or better than previously known liquid fixatives. In an alternative method, a gel fixative composition may be prepared from a thickener by adding a liquid fixative solution to it.

In one embodiment, the method of making the gel fixative composition comprises the steps of: mixing a solution of a biological fixative with a high-shear mixer at about 400 to 600 rpm; dispersing uniformly over time about 0.2 to about 2.0 weight percent of thickener while mixing for 2 to 10 minutes; increasing the mixing speed to about 1000 to 1500 rpm; and then, mixing for about 90 to 120 minutes so that the gel fixative composition has a viscosity between about 1,000 centipoise (cp) and 200,000 cp. In a preferred embodiment, the gel fixative composition has a viscosity between 2,000 cp and 75,000 cp. In a most preferred embodiment, the gel fixative composition has a viscosity between 5,000 cp and 10,000 cp.

In an alternative embodiment of the invention, the method of making the gel fixative composition comprises the steps of: adding a thickener to water and mixing to form an aqueous gel; adding a concentrated solution of a biological fixative to said aqueous gel to produce a gel mixture; optionally diluting the gel mixture to obtain the desired fixative solution concentration; and, mixing the gel mixture at a high shear speed of about 1000 to 1500 rpm for about 90 to 120 minutes so that the gel fixative composition has a viscosity between about 1,000 cp and 200,000 cp. In a preferred embodiment, the gel fixative composition has a viscosity between 2,000 cp and 75,000 cp. In a most preferred embodiment the gel fixative composition has a viscosity between 5,000 cp and 10,000 cp. Optionally, the method may include the step of warming the water prior to adding the thickener.

The gel fixative compositions of this invention fix biological tissues as well as standard liquid fixatives which have not been thickened. Tissues fixed with the gel fixative compositions of this invention have clarity results which are as good as or better than tissues fixed with standard liquid fixatives.

The gel fixative compositions of this invention also have favorable spill-preventive properties. The gel fixative compositions do not splash as easily as liquid fixative solutions and the viscosity of the gel mitigates leakage from containers, especially during transport or storage. The novel gel fixative compositions are also less likely to migrate through any cracks, seems, gaps or other imperfections in the device storing the fixative composition.

### DEFINITIONS

“Biological fixative” refers to commercial or non-commercial tissue fixative solutions which are liquid formulations. Biological fixatives may also refer to a transport medium for biological tissues. Examples of biological fixatives include 10% neutral buffered formalin solution, 10% aqueous formalin solution, other buffered and non-buffered formalin formulations, Michel's Transport Medium, and glutaraldehyde 3%.

“Gel fixative composition” refers to a biological fixative having a thickening agent (thickener) added to increase the viscosity to an amount in the range of about 1,000 centipoises to about 200,000 centipoises. Such gel fixative compositions are useful for fixing tissues and have added advantages over the prior art including decreased susceptibility to leak and decreased tendency to splash when transported in containers. Furthermore, the increased viscosity of applicant's gel fixative compositions keep them more contained than conventional fixatives in the event of a spill.

“Thickener” refers to any additive that increases the viscosity of a liquid to which it has been added. Suitable thickeners for this invention, include polysaccharides, polyacrylates, synthetic silicates, clays, and gums. Thickeners that do not leave residues or artifacts on the tissues, do not interact with the tissues, or do not add color to the fixative, are highly desirable.

### BRIEF DESCRIPTION OF DRAWINGS

FIG. 1 is a comparison of H&E stained tonsil tissue slides. One slide was fixed with 10% neutral buffered formalin and the other slide was fixed with Sample C2, a gel fixative composition of this invention.

FIG. 2 illustrates a variety of stained slides that were fixed with Cample, C2, a gel fixative composition of this invention. Slides of spleen tissue (H&E BCL1, and PAS stains), muscle tissue (trichrome stain), and lymph node tissue (Ki67 IHC stain) are represented.

### DETAILED DESCRIPTION OF THE INVENTION

For the purpose of describing the invention, several embodiments are described and illustrated below. However, it should be understood by those of ordinary skill in the art that the invention is not limited to the precise arrangements and instrumentalities shown therein and described below.

A gel fixative composition in accordance with an embodiment of the present invention comprises a biological fixative having a thickener added to it to increase its viscosity. In a preferred embodiment, the viscosity of the gel fixative composition is in the range of 1,000 centipoises to about 200,000 centipoises.

In a preferred embodiment, the biological fixative of the novel gel fixative composition comprises a liquid fixative solution. The liquid fixative solution is generally an aqueous or alcohol-containing solution. Many fixatives are comprised of aqueous formaldehyde or formalin. Representative examples of formalin/formaldehyde-containing fixatives and fixative products to be used in the invention, include, but are not limited to, 10% neutral phosphate buffered formalin, 10% neutral phosphate unbuffered formalin, neutral buffered formalin, neutral buffered (pH 7.0) formalin containers, Carson Millonig (pH 7.4) formalin containers, buffered zinc formalin, formaldehyde solution (37% by weight), alcohol formalin, Millonig's modified phosphate buffer formalin concentrate, 10% Millonig's modified phosphate buffer formalin concentrate, zinc formalin, acetic zinc formalin, Michel's Transport Medium, Hartmann's fixative, Hollandes Fixative, Bouin's fixative, and Karnovsky's fixative. A preferred fixative solution for the invention is a 10% formalin solution. A most preferred fixative solution for the invention is 10% neutral buffered formalin.

Examples of non-formaldehyde-containing fixatives that may be used in the invention include, but are not limited to, Michel's Transport Medium, glutaraldehyde 3%, B-5 fixative mercuric free, B-5 fixative with mercuric chloride, and formalin substitutes such as Optimal Fix.

In a preferred embodiment, the thickener of the novel gel fixative composition comprises at least one thickening agent added to increase viscosity. Suitable thickeners are those which do not leave residue or artifacts on the tissue or interact with the tissue in any way. In one preferred embodiment, the thickener does not add color to the fixative. Thickeners for use in this invention include, but are not limited to, polysaccharides, polyacrylates, synthetic silicates, clays, and gums.

Representative examples of suitable polysaccharide thickeners include, but are not limited to, algin, alginic acid, ammonium alginate, calcium alginate, carboxymethyl hydroxyethylcellulose, corn starch, dextrin, dibenzyldine sorbitol, gelatin, hydroxybutyl methylcellulose, hydroxyethylcellulose, hydroxyethyl ethylcellulose, hydroxyethyl stearamide-MIPA, hydroxypropylcellulose, 2-hydroxypropyl ether cellulose, hydroxypropyl methylcellulose, methoxy PEG-22/dodecyl glycol copolymer, methylcellulose, microcrystallinc cellulose, oat flour, potassium alginate, potato starch, propylene glycol alginate, sodium carboxymethyl dextran, hyalronic acid, sodium cellulose sulfate, wheat flour, wheat starch, agar, calcium carrageenan, carrageenan cellulose, potassium carrageenan, sodium carrageenan and pectin.

Representative examples of suitable polyacrylate thickeners include, but are not limited to, acrylates/steareth-20, methacrylate copolymer, ammonium acrylate copolymer, polyacrylic acid, potassium aluminum polyacrylate, sodium polymethacrylate, carbomer 910, carbomer 934P, carbomer 940, and carbomer 941.

Representative examples of suitable synthetic silicate thickeners include, but are not limited to, hydrated silica, magnesium aluminum silicate, magnesium silicate, magnesium trisilicate, montmorillonite, and sodium silicoaluminate.

Representative examples of suitable clays include, but are not limited to, montmorillonite, attapulgite, bentonite, and hectorite.

Representative examples of suitable gums thickeners include, but are not limited to, xanthan gum, guar gum, modified guar gum, gums from plant mucilage, dammar, carboymethyl hydroxypropyl guar, cellulose gum, guar hydroxypropyltrimonium chloride, hydroxypropyl guar, karaya gum, locust bean gum, and tragacanth gum.

Preferred thickeners for use in the present invention include gums such as xanthan gum, guar gum, modified guar, or other gums from plant mucilage; polysaccharide based thickeners, such as alginates, starches, and cellulosic polymers (e.g., carboxymethyl cellulose, hydroxyethyl cellulose, and the like). The most preferred thickeners are xanthan gums.

The gel fixative compositions of the invention may have viscosity ranges from about 1,000 to about 200,000 centipoise (cp), and desirably from about 2,000 to about 75,000 centipoise (cp), and preferably from about 5,000 to about 10,000 centipoise (cp). The target viscosity may vary depending on the type of tissue being preserved. The target viscosity may also vary depending on the type of environment in which the tissue sample will be shipped.

Generally, the concentration of thickener employed in the present gel fixative compositions or methods will be dictated by the desired viscosity within the final composition. However, in one preferred embodiment, the concentration of thickener within the present composition ranges from about 0.1 wt % to about 3.0 wt %, from about 0.1 wt % to about 2.0 wt %, or about 0.1 wt % to about 0.5 wt %.

The gel fixative compositions may be prepared using a method comprising the steps of:
(a) providing a solution of a biological fixative and mixing with a high-shear mixer at about 400 to 600 rpm;
(b) dispersing uniformly over time about 0.2 to about 2.0 weight percent of thickener and mixing for about 2 to 10 minutes;
(c) increasing the mixing speed to about 1000 to 1500 rpm; and,
(d) mixing for about 90 to 120 minutes,
   wherein a gel fixative composition is formed having a viscosity between about 1,000 cp and 200,000 cp.

Alternatively, the gel fixative composition may be prepared using a method comprising the steps of:
(a) adding a thickener with water and mixing to form an aqueous gel;
(b) adding a concentrated solution of a biological fixative to said aqueous gel to produce a gel mixture;
(c) optionally diluting the gel mixture to obtain the desired fixative concentration; and,
(d) mixing the gel mixture at high shear speed for about 90 to 120 minutes;
   wherein a gel fixative composition is formed having a viscosity between about 1,000 cp and 200,000 cp. When using this method, one will determine the desired final concentration of the fixative in the gel and appropriately scale the amount of water used in step (a) so that the addition of concentrated fixative solution of step (b) affords the proper dilution. Step (c) may be used to modify the concentration as needed.

In preferred embodiments, the components of applicant's novel gel fixative composition are blended at room temperature at high speed (about 2000 rpm). The blending duration is viscosity dependent. Low viscosity formulations may require only about 30 minutes of blending while high viscosity formulations may require about 1-1.5 hours of blending.

In one preferred embodiment, 10% neutral buffered formalin is thickened with xanthan gum. For example, xanthan gum may be added to the formalin in ratios of about 0.5%, 0.75% and approximately 1% to 1.5%. Samples of each of these formulations were tested in the manner set forth below.

### EXAMPLES

### Example 1

### Formulation of Gel Fixative Compositions

Xanthan Gum was added to the formalin in ratios of about 0.5%, 0.75% and approximately 1.0% to 1.5%. Samples were mixed in a laboratory using bench top mixing equipment, the later ratio yielding a viscosity that appeared to be preferable for the application. The gel is clear and retained the aroma of Formalin fixative.

### Example 2

### Studies with Various Xanthan Gums

A number of thickening agents were initially investigated including, polysaccharides, hydroxypropyl methylcellulose, polyacrylates, synthetic silicates, clays, and xanthan gums. These tests confirmed that xanthan gums would be a cost effective and viable option. Further testing was done with a variety of xanthan gum products. The xanthan gum products used for validation trials are listed in Table 1. It should be noted that the pre-hydrated varieties reduced the mixing time required to form the gel fixative compositions. The xanthan gums were mixed with 10% neutral buffered formalin using the mixing methods described below. Results of the study are shown in Table 1.

TABLE 1
Xanthan Gums mixed with 10% Neutral Buffered Formalin

| Xanthan Gum Tradename | Comment |
|---|---|
| CosmeTIC Xanthan 200-CT | Induced considerable clumping |
| | around the mixer shaft. |
| CosmeTIC Pre-Hydrated ® Xanthan | Reduced overall mixing time |
| Rapid-2 | |
| Univers Preserv ACI (Food Grade) | Significant Clumping at the |
| | Mixing Vortex |
| Pre-Hydrated ® Ticaxan ® Xanthan | Mixed well, translucent gel |
| Powder | |
| Pre-Hydrated ® Ticaxan ® Rapid | Very easy to mix, resulted in |
| Powder | slightly translucent gel |
| Ticaxan ® Xanthan Clear Powder | Significant clumping at the |
| | mixing vortex. The resulting |
| | gel was, by far, the clearest |
| | formulation made |

The results of aforementioned study show that all of the xanthan gums produced a gel fixative composition suitable for use as a fixative. Of the above-identified gels, the gel fixative composition prepared with Ticaxan®Xanthan Clear Powder produced the most transparent gel.

Mixing Ratios—The majority of testing was done by adding xanthan gum to a premixed 10% neutral buffered formalin solution. The formalin solution was received premixed and comprised [1] formaldehyde (3-4%), [2] methyl alcohol (˜1%), [3] mono sodium phosphate (<1%), [4] dibasic sodium phosphate (<1%) and [5] purified water.

As an alternative, a few test samples were made by adding 56% concentrated formalin to water that was premixed with xanthan gum to form an aqueous gel. Volumes were adjusted to yield the same formaldehyde concentration as the 10% neutral buffered formalin solution. This technique was successful and allowed for preheating the solvent prior to adding the solute.

Mixing Techniques—A variety of methods were used for mixing the gel:

Initial testing of the formulation indicated that bench top mixing using a magnetic stirrer in a beaker was insufficient for creating the gel formulation. It appears that the limited surface area of a magnetic stirrer will not work for thicker materials. Multiple samples were stirred for as long as 18 hours without even mixing of the gel.

Better mixing could be accomplished by warming the solution prior to adding the xanthan gum to increase the solubility. However, heating formalin solution directly could release alcohol vapor and evolve formaldehyde gas. It was determined that the purified water could be heated and the xanthan gum added to make a gel from just the water. A secondary step was added to mix a concentrated formalin solution to the aqueous gel. This technique did reduce the mix time but this technique was not determined to be optimal for bench top work.

The best mixing is achieved by using a paddle mixer. Both a four blade “medium-shear” type (2 inch diameter) and a two position “high-shear” type mixer were used. The bench top process is optimized by using the medium shear paddle and starting out at slow mixing speeds (400 to 600 rpm), and adding the powdered xanthan gum over a period of 40 to 60 seconds. Once initial mixing was completed (2 to 10 minutes) the mixer speed was increased to a higher speed (1000 to 1500 rpm). The batch was maintained at this speed for 90 to 120 minutes with excellent results.

### Example 3

### Preparation of Gel Fixative Compositions Using Xanthan Gums

The gel formulation compositions of Table 4 were prepared from 10% Neutral Buffered Formalin and Ticaxan®Xanthan. Clear Powder, a commercial xanthan gum. The gel formulation compositions were prepared in a laboratory, using mixing technique 3) disclosed in Example 2. Table 4 shows the ratio of Ticaxan®Xanthan Clear Powder to 10% neutral buffered formalin used for each sample. The ratio is expressed as a weight percent (X grams of thickener to Y liters of liquid formalin solution). Viscosities of the various samples prepared are also listed. Sample C and Sample C2 had viscosities that were preferable for use in fixative applications.

TABLE 4
Gel Formulations Compositions Prepared by Mixing Technique 3

| | Viscosity | wt % |
|---|---|---|
| Sample | (centipoise (cp)) | (grams/liter) |
| A | 1,960 | |
| C2 | 3,000 | 0.50% |
| B | 3,040 | |
| C | 6,020 | 0.65% |
| O | 7,540 | 0.90% |
| P | 8,580 | 1.00% |
| H | 9,820 | 1.90% |
| Q | 10,320 | |
| D | 12,400 | |
| K | 14,520 | 1.60% |
| L | 15,520 | |
| M | 16,220 | |
| J | 16,440 | |
| E | 21,500 | |
| F | 36,500 | |
| G | 64,400 | |

### Example 4

### Studies of Staining Properties with Gel Fixative Composition Sample C

Gel fixative formulation Sample C was placed inn “pre-filled” (half-filled) 20 mL containers and sent to a local laboratory for fixation use on a standard tissue sample in direct comparison with unmodified 10% neutral buffered formalin.

A sample of human tonsil tissue was used for all testing. Sections of the identical tissue sample were exposed to either the gel fixative composition (Sample C) or standard liquid fixatives (10% neutral buffered formalin) for one (1) hour, two (2) hours, three (3) hours, four (4) hours, and overnight.

After fixation, three staining procedures, (1) H&E (Hematoxylin and Eosin stain), (2) Vimentin V (standard immune-marker to test viability of tissue for staining) and (3) Neg-M (negative control stain), were performed on the samples and the resulting slides were compared by a pathologist using microscopy. In each case, the samples fixed using Sample C were determined to be of equal quality to or better than the samples fixed using the standard 10% neutral buffered formalin. Results of the study are shown in Tables 5-7. All tests were replicated.

TABLE 5
Hematoxylin and Eosin Stain Tests with Sample C

| | | Identifier for Slide | | |
|---|---|---|---|---|
| | Exposure | Tested in 10% | | |
| Stain | Time | Neutral Buffered | Identifier for Slide | |
| Process | [Hour] | Formalin | tested in Sample C | Correlation |
| H & E | 1 | Formalin 1 | Test 1 | good |
| H & E | 2 | Formalin 2 | Test 2 | good |
| H & E | 3 | Formalin 3 | Test 3 | good |
| H & E | 4 | Formalin 4 | Test 4 | good |
| H & E | Overnight | Formalin OVN | Test OVN | good |

TABLE 6
Vimentin V (Standard Immune-Marker to Test Viability of
Tissue for Staining) Tests with Sample C

| | | Identifier for Slide | | |
|---|---|---|---|---|
| | Exposure | Tested in 10% | Identifier for | |
| Stain | Time | Neutral Buffered | Slide tested | |
| Process | [Hour] | Formalin | in Sample C | Correlation |
| Vimentin V | 1 | Formalin 1 | Test 1 | good |
| Vimentin V | 2 | Formalin 2 | Test 2 | good |
| Vimentin V | 3 | Formalin 3 | Test 3 | good |
| Vimentin V | 4 | Formalin 4 | Test 4 | good |
| Vimentin V | Overnight | Formalin OVN | Test OVN | good |

TABLE 7
Negative Control Stain (Neg-M) Tests with Sample C

| | | Identifier for Slide | | |
|---|---|---|---|---|
| | Exposure | Tested in 10% | | |
| Stain | Time | Neutral Buffered | Identifier for Slide | |
| Process | [Hour] | Formalin | tested in Sample C | Correlation |
| Neg-M | 1 | Formalin 1 | Test 1 | good |
| Neg-M | 2 | Formalin 2 | Test 2 | good |
| Neg-M | 3 | Formalin 3 | Test 3 | good |
| Neg-M | 4 | Formalin 4 | Test 4 | good |
| Neg-M | Overnight | Formalin OVN | Test OVN | good |

### Example 5

### Validation Study. Comparison and Validation Study of Gel Fixation Composition, Sample C2, and Traditional 10% Neutral Buffered Formalin

A pathology laboratory was contracted to conduct a comparative study between a gel fixation composition (Sample C2) and standard 10% neutral buffered formalin fixed tissues. This validation study was designed to examine the quality, integrity and preservation of these tissues.

Fixation is the first stage in a multistep process to prepare a surgical specimen sample for microscopy or other analysis. Tissue fixation must demonstrate preservation of the integrity and morphology of cells and, tissues so they can withstand the harsh conditions of dehydration, clearing, embedding and staining that are performed during routine histological processes. In addition, fixation also helps prevent decomposition, putrefaction, autolysis of tissues and optimizes tissue morphology for proper microscopic evaluation.

The current standard for proper fixation of histological studies, is achieved when a sample of tissue is immersed in a 10% neutral buffered formalin fixative at a minimum volume of 10-20 times greater than the volume of the tissue to be fixed. 10% neutral buffered formalin has proven, over several years, to successfully diffuse through the tissue to render appropriate fixation processes.

A total of 33 fresh tissue specimens were randomly selected and placed in Sample C2, a gel fixative composition prepared as in Example 3. Additional samples of the same tissues were also processed in standard 10% neutral buffered formalin liquid fixative as a control.

Routine histological sections were processed using the two fixatives followed by microscopic side by side comparison. Various histochemical (6) and immunohistochemical (11) staining procedures were also performed to determine reactivity of the stains to the tissues fixed in Sample C2 gel fixative composition.

For comparison of the histologic sections, five (5) qualitative criteria were utilized:
a) Hematoxylin uptake (strength of stain, color, density)
b) Eosin uptake (strength of stain, color, density)
c) Cellular details (nuclear/cytoplasmic details, crispness, clarity)
d) Overall morphology (tissue in its entirety, optimal to render accurate diagnosis)
e) Background (clean)

The above criteria were evaluated and scored 1-4; score 1 being poor and unacceptable and score 4 being high quality. In the standard histology laboratory scores of 3 or 4 are acceptable for diagnostic purposes. Notation of the background was also noted. The immunohistochemistry and histochemical stains were scored 0 (negative) to 4+ depending on the strength of stain. Notation of the background was also noted.

### Results

Histologic sections (Hematoxylin/Eosin staining): Based on the first four qualitative criteria and the scoring used to evaluate the fixative properties of Sample C2 and 10% neutral buffered formalin, the results demonstrate that these two fixatives are comparable to those routinely fixed in 10% liquid neutral buffered formalin. The majority of the specimens of both fixatives scored 4 on staining uptake, cellular detail, and overall morphology equivalent to routine 10% liquid formalin fixation.

We observed the presence of minimal residual deposits (appearing to be precipitate) when Sample C2 was used that were not identified with 10% liquid formalin in Case 125. These residual deposits were often noted on the surrounding edges of the tissue and were not superimposed on the actual tissue. The “background” section on the summary worksheet scored the residual deposit findings (1) as minimal/light and (2) as heavy/dark.

Histochemical/Immunohistochemical staining: Based on the criteria used, 0-4+ (depending on the intensity of the stain), Sample C2 fixed samples demonstrated appropriate staining intensities as expected. Similarly as in the hematoxylin and eosin preparations, a residual on tissue edges was still noted, however, it was of lesser degree and only sporadically noted in a few specimens.

The study also was used to validate the quality, integrity and preservation of tissue using Sample C2. Our findings are shown in Table 8 and indicate that the gel fixative composition tissues are comparable with that of 10% liquid formalin on the 33 histologic specimens and the 16 special stains included in this study.

TABLE 8
Results of Validation Study Comparing Sample C2 with 10% Liquid Formalin Solution.

| | | Tissue | | 10% | Sample | | |
|---|---|---|---|---|---|---|---|
| Case # | Diagnosis | Type | Stain | Formalin | C2 | Background | Comment |
| 102 | Gastric body with no | stomach | Mucin | na | 0 | (neg control) | As expected no |
| | significant pathologic | | | | | | uptake of mucin |
| | findings | | | | | | in stomach lining |
| | | | Alcian | na | 3+ | | As expected |
| | | | blue | | | | uptake of |
| | | | | | | | mucoproteins |
| 110 | Gastric body with mild | stomach | LCA | na | 4+ | | As Expected |
| | chronic gastritis. | | Leu M1 | na | 4+ | | As Expected |
| 111 | Diffuse Large B Cell | lymph | CD45 | 4+ | 4+ | | As Expected |
| | Lymphoma | node | CD15 | Neg | Neg | | As Expected |
| | (T-cell/histocyte rich | | Ki67 | 4+ | 4+ | | As Expected |
| | variant), see comment | | | | | | |
| 112 | disordered | Uterus | Smooth | na | 4+ | | As Expected |
| | proliferative pattern | | Muscle | | | | |
| | endometrium. | | Actin | | | | |
| | Multiple leiomyomata. | | | | | | |
| | Focal adenomyosis. | | | | | | |
| 117 | a. Well differentiated | Colon | CEA | na | 4+ | | As Expected |
| | colonic | | | | | | |
| | adenocarcinoma. (See | | | | | | |
| | Synopsis). B. 16 | | | | | | |
| | Benign lymph nodes. | | | | | | |
| 118 | Pt1 dermal fibrosis | Skin | CYP | na | 4+ | | As Expected |
| | (see comment). Pt2 a. | | | | | | |
| | dermal fibrosis and | | | | | | |
| | focal fat necrosis (see | | | | | | |
| | comment). B. small | | | | | | |
| | squamous inclusion | | | | | | |
| | cyst. | | | | | | |
| 125 | Acute diverticulitis | colon | Pas | na | 4+ | 1 | As expected |
| | with focal rupture, | | | | | | mucin staining |
| | abcess formation and | | Pas with | na | 4+ | 1 | As expected |
| | associated serositis | | dig | | | | mucin staining |
| 126 | gangrenous necrosis | muscle | Trichrome | na | 4+ | | As expected |
| | with ulceration. | | | | | | muscle stained |
| | Calcific atherosclerosis | | | | | | sharp |
| | and arteriosclerosis | skin | Trichrome | na | 4+ | | As expected |
| | with focal thrombosis. | | | | | | |
| | Margins of resection | | | | | | |
| | histologically viable | | | | | | |
| 127 | MANTLE CELL | spleen | CD20 | 3+ | 4+ | | As expected |
| | LYMPHOMA (see | | | | | | slightly sharper |
| | synopsis and | | | | | | than liquid |
| | comment) | | | | | | formalin |
| | | | BCL1 | 4+ | | | |

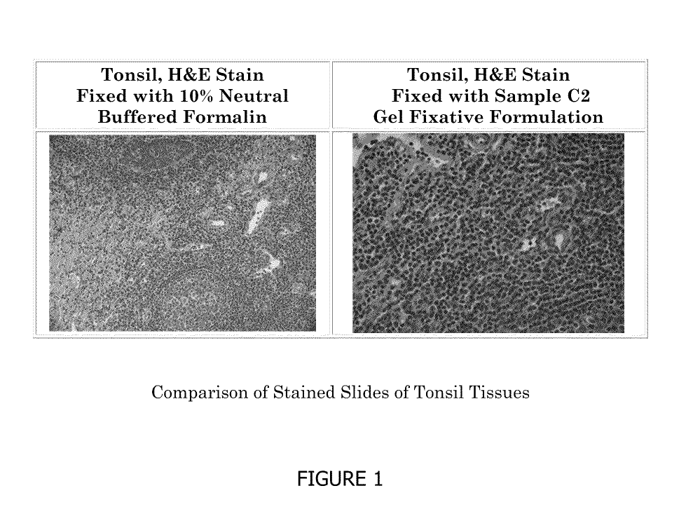

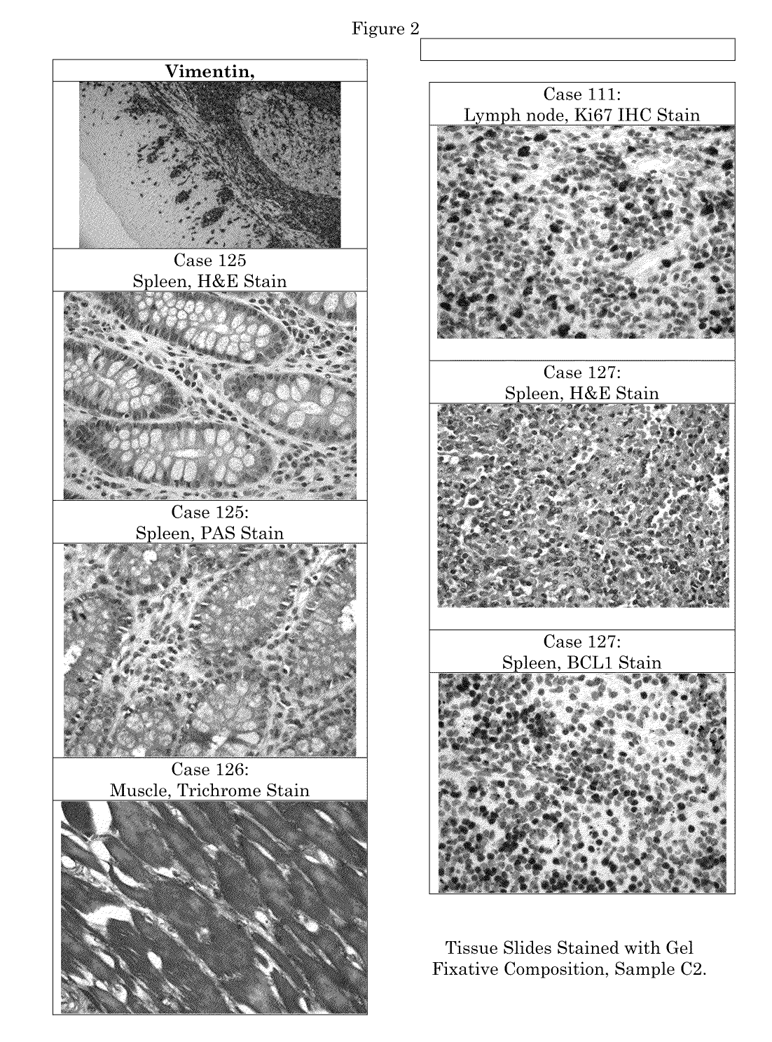

FIG. 1 shows a slide of stained tonsil tissue fixed with Sample C2 and compares the slide with a slide of stained tonsil tissue fixed with standard 10% formalin fixative. FIG. 2 shows seven representative slides of stained tissues fixed with Sample C2. The validation study of Sample C2 presented in Table 8 and the visual representations shown in FIGS. 1 and 2 show the fixation quality of Sample C2 is identical, if not improved over standard liquid 10% neutral buffered formalin.

### Example 6

### Freeze/Thaw study of Sample C2

This study was done to test the stability and functionality of Sample C2 when frozen and later thawed. From these test, we found that freezing will not have an effect on the fixative properties of Sample C2. Users who allow the gel fixative formulations of the invention to freeze, either in transport or the like, should let the gel fixative composition thaw at room temperature prior to use.

Three samples of Sample C2 from two production lots were frozen for 67.5 hours in a freezer at −11° C. The samples were removed from the freezer, and let stand at room temperature (˜68° F.) until thawed. Physical observations were made at half-hour increments, and pH was recorded at the end of the thaw. Table 9 illustrates the freeze/thaw results from this study.

TABLE 9
Freeze/Thaw Results after freezing Sample C2 for 67.5 hours

| | Sample C2 | | | Sample C2 | | |
|---|---|---|---|---|---|---|
| | Lot #0308 | | | Lot #0299 | | |
| | 1 | 2 | 3 | 1 | 2 | 3 |
| Time 0 | F | F | F | F | F | F |
| Time .5 hr | F | F | F | F | F | F |
| Time 1 hr | G | G | G | G | G | G |

F = frozen
G = gel

### Example 7

### Automated Hematoxylin/Eosin Staining

PRINCIPLE: The Hematoxylin and Eosin stain (HU) is the most used diagnostic stain in histology. Therefore consistency and reproducibility are of the utmost importance.
SPECIMEN: All routine Pathology slides.
REAGENTS: The reagents needed are as follows:
1. Hematoxylin
2. Eosin Y Alcoholic
3. Xylene
4. 100% Alcohol
5. 95% Alcohol
6. Running Tap Water
7. Distilled Water
8. Clarifer
9. Bluing
   PROCEDURE: The solution placements in the automated stainers are as follows:

| Station | Sakura Tissue-Tek Prisma |
|---|---|
| Station #1 | Xylene |
| Station #2 | 100% Alcohol |
| Station #3 | 100% Alcohol |
| Station #4 | 100% Alcohol |
| Station #5 | 95% Alcohol |
| Station #6 | Running Water |
| Station #7 | Running Water |
| Station #8 | Dryer |
| Station #9 | Xylene |
| Station #10 | Xylene |
| Station #11 | 100% Alcohol |
| Station #12 | 100% Alcohol |
| Station #13 | Eosin |
| Station #14 | Clarifier |
| Station #15 | Hematoxylin |
| Station #16 | Dryer |
| Station #17 | (not used) |
| Station #18 | Xylene |
| Station #19 | Xylene |
| Station #20 | 100% Alcohol |
| Station #21 | 95% Alcohol |
| Station #22 | 95% Alcohol |
| Station #23 | Bluing |
| Station #24 | DI H₂O |
| Station #25 | Xylene E1 |
| Station #26 | Xylene E2 |
| Station #27 | Xylene E3 |
| Station #28 | Xylene S3 |
| Station #29 | Xylene S2 |
| Station #30 | Xylene S1 |

The stepwise procedure for automated H&E staining with the Sakura Tissue-Tek Prisma is listed below:

| Step | Station | Solution | Time | |
|---|---|---|---|---|
| 1 | 10 | Xylene | 3 | min |
| 2 | 9 | Xylene | 3 | min |
| 3 | 1 | Xylene | 3 | min |
| 4 | 2 | 100% Alcohol | 1 | min |
| 5 | 3 | 100% Alcohol | 30 | sec |
| 6 | 4 | 100% Alcohol | 30 | sec |
| 7 | 5 | 95% Alcohol | 30 | sec |
| 8 | WASH | Running Water | 30 | sec |
| 9 | 24 | Distilled Water | 15 | sec |
| 10 | 15 | Hematoxylin | 45 | sec |
| 11 | WASH | Running Water | 30 | sec |
| 12 | WASH | Running Water | 30 | sec |
| 13 | 14 | Clarifier | 45 | sec |
| 14 | WASH | Running Water | 1 | min |
| 15 | 23 | Bluing | 45 | sec |
| 16 | WASH | Running Water | 1 | min |
| 17 | 22 | 95% Alcohol | 20 | sec |
| 18 | 21 | 95% Alcohol | 20 | sec |
| 19 | 13 | Eosin | 5 | sec |
| 20 | 12 | 100% Alcohol | 20 | sec |
| 21 | 20 | 100% Alcohol | 20 | sec |
| 22 | 11 | 100% alcohol | 20 | sec |
| 23 | 19 | xylene | 20 | sec |
| 24 | 18 | xylene | 20 | sec |
| END | | | | |

Procedure for operating the Sakura Tissue-Tek Prisma Automated Stainer

### I. First Run of Day

1. Turn stainer on (black button at bottom right)
2. Touch “Logon” button on screen and enter code “100000”
3. Touch “Start” on screen
4. Follow instructions on screen
5. After loading baskets touch “Start”, it will return the overview screen automatically go when the door is closed

### II. Additional Racks

1. Press “Add Baskets”
2. Follow instructions on screen
3. Do not touch anything will pick up slides and return to overview screen when the door is closed
   III. To Remove Slides from Coverslipper
1. The stainer and the coverslipper are “linked”, after the slides are stained they are automatically taken to the coverslipper
2. When the lid light is green the holding carousel may be lifted to removed coverslipped slides
3. When the load light is green more slides may be loaded manually (if needed) in the xylene chamber

### Maintenance

Solutions need to be changed or rotated on a daily basis. This ensures a consistent stain day to day.
1. Solutions are changed on the stainer by a rotation format.
2. The first containers of like solutions are removed and the solution discarded. For example the stainer has 4 Xylenes. The first Xylene is removed and the solution discarded. The xylene next to it would be rotated into this spot and so down the line until you come to the last Xylene space, which is now empty.
3. The first container is now empty and has been rinsed and cleaned
4. This container is refilled with the proper solution. In our example Xylene and the fresh reagent becomes the last reagent of its type.
5. This solution exchange can be done for all the reagents with multiple locations, which are located together.
6. The following solutions cannot be rotated and must always be changed. 95% Alcohol, Hematoxylin, Eosin, Clarifier, Bluing and DI H₂O.
7. The stainer can also be entirely changed without rotation.
8. All containers must be cleaned when they are empty.
9. All solutions changed must be recorded in the solution change log.
*There is a solution configuration chart (located on the side of the stainer) for the stations that need to be rotated and, the ones that need to be emptied, cleaned, dried and refilled.

### Example 8

### Immunohistochemistry Procedure

PRINCIPLE: To detect specific proteins in tissue sections using antibody-antigen reaction.

### Specimen:

Cut paraffin sections at 4-5 microns and place at bottom (labeled PATIENT/opposite from label end) of FisherBrand Superfrost/Plus Control/Patient slides.

### Preparation of Reagents:

| | |
|---|---|
| Xylene | Bluing |
| Absolute Alcohol | Amplification Kit |
| 95% Alcohol | A/B Block |
| EZ Prep | Protease 1, Protease 2 |
| LCS | Detection Kit |
| SSC | Dawn Detergent |
| Reaction Buffer | graduated pipettes (1 mL, 5 mL, 10 mL) |
| CC1 | Primary Antibodies (see attached listing) |
| CC2 | Barcode labels |
| Hematoxylin | |

### Quality Assurance:

A section of positive control tissue is used for each IHC antibody and a section of tissue from each case is run as a negative control.

### Procedure:

1. Cut 4-5 micron sections of tissue and place on the PATIENT end of the appropriate control slide (located in labeled slide boxes in the cabinet above the block organization area). Cut two additional slides to serve as a patient negative control slide.
   HRA Panel: cut 1 slide to be stained H&E and kept with panel
2. Place all slides (patient and control) flat on a metal tray into the 60° C. oven for a minimum of 30 minutes.
   HRA Panel: run 1 negative slide for a given HRA run.
3. Turn on PC and Benchmark XT staining modules (Felix, Oscar and Sparkle).
4. Order appropriate tests in Cerner (COE Additional Test), print worksheet, and verify ordered tests.
5. Order and print bar coded slide labels from Benchmark XT,
6. Each Benchmark XT wheel holds 30 slides. Organize slides to be run according to antibody protocol. Place appropriate antibodies on the wheel(s), remove all caps and check fluid levels.
7. Remove slides from oven, attach proper labels, and place into Benchmark XT stainer.
8. Select proper stainer module and click on RUN.
9. Check all appropriate boxes and enter number of slides on that particular machine.
10. If errors appear, correct and restart. Stainer runs approximately 3 hours.
11. Fill out record log, daily workload log and the run report log.
12. When stainer is finished: Remove slides from stainer, place in slide rack, and wash in warm running water with Dawn detergent until water runs clear (to remove liquid coverslip).
13. Dehydrate slides through graded alcohols, clear in xylene, and coverslip slides using Sakura Prisma automated coverslipper (using 45 mm setting for film length). There is no need to relabel the slides.
   NOTE: if AEC is used, slides must be coverslipped from water with Faramount Aqueous Mounting Media.
14. Check quality microscopically, and complete Breast Prognostic Cancer Panel Worksheet for HRA Panels (see attached).
15. Distribute slides to appropriate pathologist.
16. Remove antibodies from wheel and recap all solutions. Return antibodies and wheel(s) to refrigerator.
17. Shut down Benchmark XT.
18. Shut down PC (using START button in lower left corner of screen)
19. For detailed user information consult the Benchmark user Guide.

### RESULTS

Positive reactions will appear as dark brown if using DAB, or red if using V Red. Ventana Bench Mark User's Guide, Ventana Medical Systems, Inc., Tuscon, Ariz., revised Feb. 14, 2005.

In light of the general disclosure provided herein above, with respect to the manner of practicing this inventive method, those skilled in the art will appreciate that this disclosure enables the practice of the invention according to the embodiments disclosed above. However, the above experimental details are provided to ensure a complete written description of this invention, including the best mode thereof. However, it will be appreciated that the scope of this invention should not be construed in terms of the specific examples provided. Rather, the scope of this invention is to be apprehended with reference to the claims appended hereto, in light of the complete description of this inventive method constituted by this entire disclosure.

It is to be understood that the present invention may have various other embodiments. Furthermore, while the form of the invention herein shown and described constitutes a preferred embodiment of the invention, it is not intended to illustrate all possible forms thereof. It will also be understood that the words used are words of description rather than limitation, and, that various changes may be made without departing from the spirit and scope of the invention disclosed. The scope of the invention should not be limited solely to the examples given.

1. A gel fixative composition comprising a biological fixative and about 0.2 to 2.0 weight percent of a thickener.

2. The gel fixative composition of claim 1, comprising about 0.5 to 1.5 weight percent of said thickener.

3. The gel fixative composition of claim 1, comprising about 0.9 to 1.1 weight percent of said thickener.

4. The gel fixative composition of claim 1, wherein said biological fixative is a formaldehyde-containing fixative.

5. The gel fixative composition of claim 4, wherein said formaldehyde-containing fixative is selected from the group consisting of 10% neutral phosphate buffered formalin, 10% neutral phosphate unbuffered formalin, neutral buffered formalin, neutral buffered (pH 7.0) formalin containers, Carson Millonig (pH 7.4) formalin containers, buffered zinc formalin, formaldehyde solution (37% by weight), alcohol formalin, Millonig's modified phosphate buffer formalin concentrate, 10% Millonig's modified phosphate buffer formalin concentrate, zinc formalin, acetic zinc formalin, Michel's Transport Medium, Hartmann's fixative, Hollandes Fixative, Bouin's fixative, and Karnovsky's fixative.

6. The gel fixative composition of claim 5, wherein said biological fixative is 10% formalin or 10% neutral buffered formalin.

7. The gel fixative composition of claim 1, wherein said thickener is selected from the group consisting of polysaccharides, polyacrylates, synthetic silicates, clays, and gums.

8. The gel fixative composition of claim 7, wherein said thickener is a gum.

9. The gel fixative of claim 8, wherein said gum is a xanthan gum.

10. The gel fixative composition of claim 7, wherein said thickener is a polysaccharide selected from the group consisting of alginates and cellulose derivatives.

11. The gel fixative composition of claim 10, wherein said cellulose derivative is selected from the group consisting of hydroxypropylcellulose, hydroxyethylcellulose, and hydroxyethyl ethylcellulose.

12. A method of preparing a gel fixative composition comprising the steps of:
a. mixing a solution of a biological fixative with a high-shear mixer at about 400 to 600 rpm;
b. dispersing uniformly over time about 0.2 to about 2.0 weight percent of thickener while mixing for 2 to 10 minutes;
c. increasing the mixing speed to about 1000 to 1500 rpm; and then,
d. mixing for about 90 to 120 minutes;
wherein a gel fixative composition is formed having a viscosity between about 1,000 cp and 200,000 cp.

13. The method of claim 12, wherein said gel, fixative composition has a viscosity between about 5,000 cp and 10,000 cp.

14. A method of preparing a gel fixative composition comprising the steps of:
a. adding a thickener to water and mixing to form an aqueous gel;
b. adding a concentrated solution of a biological fixative to said aqueous gel to produce a gel mixture;
c, optionally diluting the gel mixture to obtain the desired fixative solution concentration; and,
d. mixing the gel mixture at a high shear speed of about 1000 to 1500 rpm for about 90 to 120 minutes;
wherein a gel fixative composition is formed having a viscosity between about 1,000 cp and 200,000 cp.

15. The method of claim 14, wherein said gel fixative composition has a viscosity between about 5,000 cp and 10,000 cp.

16. The method of claim 15, wherein the water of step (a) is warmed prior to adding the thickener.
